(19) United States
(12) Patent Application Publication
(10) Pub. No.: US 2018/0267811 A1
(43) Pub. Date: Sep. 20, 2018

(54) ELECTRONIC APPARATUS AND CONTROL METHOD OF THE SAME

(71) Applicant: Yoshiki MATSUMOTO, Kanagawa (JP)

(72) Inventor: Yoshiki MATSUMOTO, Kanagawa (JP)

(73) Assignee: Ricoh Company, Ltd., Tokyo (JP)

(21) Appl. No.: 15/904,613

(22) Filed: Feb. 26, 2018

(30) Foreign Application Priority Data
Mar. 17, 2017 (JP) 2017-053698

(51) Int. Cl. G06F 9/4401; G06F 1/32

(52) U.S. Cl. CPC G06F 9/4401; G06F 1/3234

(57) ABSTRACT

An electronic apparatus includes a first controller to control a device other than a mechanical device that operates mechanically, a second controller to control the mechanical device that operates mechanically, and a third controller. The third controller detects that power supply to the electronic apparatus is secured, and causes, in response to detection of the power supply being secured, the first controller to perform a cold boot and transition to a standby state and causes the second controller not to perform the cold boot.

### CROSS-REFERENCE TO RELATED APPLICATION

This patent application is based on and claims priority pursuant to 35 U.S.C. § 119(a) to Japanese Patent Application No. 2017-053698, filed on Mar. 17, 2017, in the Japan Patent Office, the entire disclosure of which is hereby incorporated by reference herein.

### BACKGROUND

### Technical Field

The embodiments of the present disclosure relate to an electronic apparatus and a control method of the same.

### Related Art

An electronic apparatus uses a known technique of reducing power consumption by automatically switching an operating mode to an energy-saving mode, or a standby mode, a suspend mode, a sleep mode, etc., when the electronic apparatus is not operated for a certain period. In such an electronic apparatus, when power supply is disconnected because, for example, a plug for the power supply is disconnected or charge of a battery is not remained enough, a user is required to perform a cold boot to start up the electronic apparatus by pressing a power source button after the power supply is secured. In such a situation, the electronic apparatus is in a state where the energy-saving mode is canceled.

### SUMMARY

An electronic apparatus includes a first controller to control a device other than a mechanical device that operates mechanically, a second controller to control the mechanical device that operates mechanically, and a third controller. The third controller detects that power supply to the electronic apparatus is secured, and causes, in response to detection of the power supply being secured, the first controller to perform a cold boot and transition to a standby state and causes the second controller not to perform the cold boot.

### BRIEF DESCRIPTION OF THE DRAWINGS

A more complete appreciation of the disclosure and many of the attendant detailed description with reference to the accompanying drawings, wherein:

FIG. 1 is block diagram illustrating a functional configuration of a multifunction peripheral (MFP) according to one of the embodiments of the disclosure;

FIG. 2 is a block diagram illustrating another functional configuration of the MFP according to one of the embodiments of the disclosure;

FIG. 3 is a flowchart illustrating a start control process performed by the MFP (main controller) according to one of the embodiments of the disclosure;

FIG. 4 is a flowchart illustrating a power supply detection process performed by the MFP (main controller) according to one of the embodiments of the disclosure;

FIG. 5 is a flowchart illustrating an instruction process for a pre-boot, performed by the MFP (main controller) according to one of the embodiments of the disclosure;

FIG. 6 is a graph illustrating a boot time of the MFP according to one of the embodiments and a boot time of an MFP according to a comparative example;

FIG. 7 is a block diagram illustrating a functional configuration of the MFP according to a second modification;

FIG. 8 is a flowchart illustrating a pre-boot interruption process performed by the MFP (main controller) according to the second modification;

FIG. 9 is a flowchart illustrating an interface (I/F) connection establishment process performed by the MFP (main controller) according to a third modification;

FIG. 10 is a flowchart illustrating a power supply detection process performed by the MFP (main controller) according to a fourth modification;

FIG. 11 is a flowchart illustrating a pre-boot interruption process performed by the MFP (main controller) according to a fifth modification;

FIG. 12 is a flowchart illustrating a pre-boot check process performed by the MFP (main controller) according to a fifth modification; and

FIG. 13 is an example of a table that is stored in the MFP according to one of the embodiment.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operation in a similar manner, and achieve a similar result.

### One of Embodiments

One of the embodiments of the present disclosure is described below with reference to the drawings. In the following description of the embodiment, a multifunction peripheral (MFP) 10 is used as an example of an “electronic apparatus”.

### (Configuration of MFP 10)

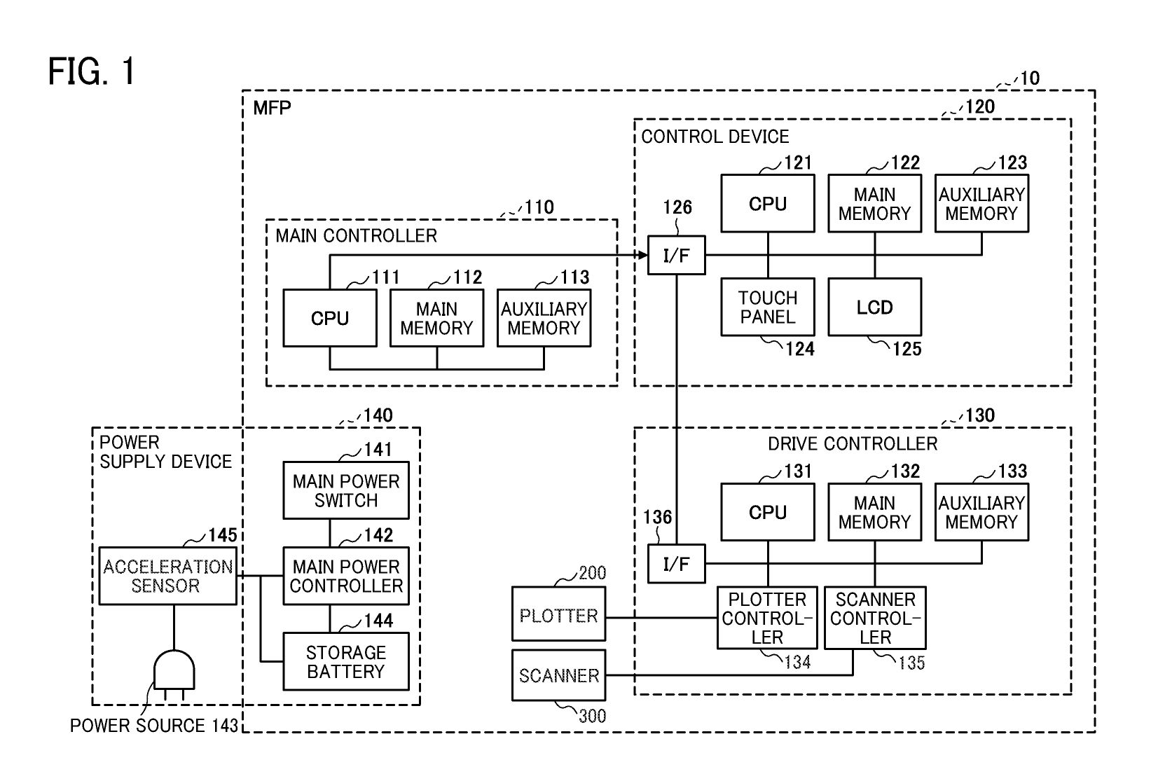

FIG. 1 is a diagram illustrating a configuration of the MFP 10 according to the present embodiment. The MFP 10 illustrated in MG. 1 has multiple image processing functions such as copying, scanning, faxing, and printing. As illustrated in FIG. 1, the MFP 10 includes a main controller 110, a control device 120, a drive controller 130, and power supply device 140.

The main controller 110 controls overall operation of the MFP 10. The main controller 110 includes a central processing unit (CPU) 111, a main memory 112, and an auxiliary memory 113. The CPU 111 executes various types of programs stored in the main memory 112 or the auxiliary memory 113. The main memory 112 stores the various types of programs executed by the CPU 111 and various types of data required for executing each program, which is executed by the the CPU 111. The main memory 112 also serves as a working area to be used when each program is executed by the CPU 111. As examples of the main memory 112, a read only memory (ROM), a random access memory (RAM), or the like is used. The auxiliary memory 113 stores the various types of programs executed by the CPU 111 and data required for executing each program, which is executed by the CPU 111. As examples of the auxiliary memory 113, a hard disc drive (HDD), a flash memory, or the like is used.

The control device 120 is used by a user to select an image processing function to be performed with the MFP 10, input one or both of various types of setting values and instructions for the image processing function, and switch a display screen, for example. The control device 120 includes a CPU 121, a main memory 122, an auxiliary memory 123, a touch panel 124, a liquid crystal display (LCD) 125, and an interface (I/F) 126. The CPU 121, the main memory 122, and the auxiliary memory 123 are the same as or similar to the CPU 111, the main memory 112, and the auxiliary memory 113, respectively, of the main controller 110, and the description thereof is omitted. The touch panel 124 receives various inputs from the user. The LCD 125 displays various screens. The I/F 126 is connected to an I/F 136 of the drive controller 130 to transmit and receive various types of data to and from the drive controller 130. The I/F 126 is also connected to the main controller 110, to establish a connection with the drive controller 130 according to an instruction from the main controller 110 (CPU 111). In some of the embodiments, I/F 126 serves as an interface that transmits and receives various types of data to and received from the main controller 110 (CPU 111). In the example embodiment illustrated FIG. 1, the I/F 126 is directly connected to the CPU 111 of the main controller 110, however the embodiment is not limited to this and the I/F 126 may be connected to the CPU 111 of the main controller 110 via the I/F 136 of the drive controller 130, for example.

The drive controller 130 controls mechanical devices that operate mechanically, for example, such as a plotter 200 and a scanner 300. Namely, the drive controller 130 operates by mechanical control. The drive controller 130 includes a CPU 131, a main memory 132, an auxiliary memory 133, a plotter controller 134, a scanner controller 135, and the I/F 136. The CPU 131, the main memory 132, and the auxiliary memory 133 are the same as or similar to the CPU 111, the main memory 112, and the auxiliary memory 113, respectively, of the main controller 110, and the description thereof is omitted. The plotter controller 134 controls driving of the plotter 200 included in the MFP 10. The scanner controller 135 controls driving of the scanner 300 included in the MFP 10. The I/F 136 is connected to the I/F 126 of the control device 120, and transmits and receives various data to and from the control device 120. In some of the embodiments, the I/F 136 is connected to the main controller 110 via the I/F 126 of the control device 120, and transmits and receives various data to and from the main controller 110 (CPU 111). In the example embodiment illustrated FIG. 1, the 136 is connected to the CPU 111 of the main controller 110 via the I/F 126 of the control device 120, however the embodiment is not limited to this and the 136 may be directly connected to the CPU 111 of the main controller 110, for example. When being directly connected to the main controller 110 (CPU 111), the I/F 136 establishes a connection with the control device 120 according to an instruction from the main controller 110 (CPU 111).

The power supply device 140 controls electric power supplied from an external power source. The power supply device 140 includes a main power switch 141, a main power controller 142, an alternating current (AC) plug 143, a storage battery 144, and an acceleration sensor 145. The main power switch 141 switches between ON and OFF in starting the MFP 10. The main power controller 142 converts the power supplied from the external power source, from an AC voltage to a direct current (DC) voltage. The DC voltage output from the power supply device 140 is provided to each of elements (for example, the control device 120, and the drive controller 130) of the MFP 10. The AC plug 143 is plugged into an outlet to receive supply of electric power from the external power source. The storage battery 144 is chargeable with the electric power supplied from the external power source. The electric power charged in the storage battery 144 is usable as electric power for operating the MFP 10 when the electric power from the external power source is cut off, for example. The acceleration sensor 145 is provided in a cable section of the AC plug 143 and capable of detecting whether the cable section is moving or not. That is, the acceleration sensor 145 detects the change in position of the cable section.

With the configuration described above of the MFP 10 according to the present embodiment, the control device 120 (an example of a “first controller” of the disclosure), which does not operate with the mechanical control, performs a cold boot and transition a state of the control device 120 to a standby state, and the drive controller 130 (an example of a “second controller” of the disclosure), which operates with the mechanical control, does not perform the cold boot, when the electronic power from the power supply from the external power source is secured. This allows the MFP 10 according to the present embodiment to suppress unnecessary operation and reduce the power consumption when the external power supply is secured. A detailed description of this is given below. In the following description, a process of performing the “cold boot” and transitioning to the standby state is referred to as a “pre-boot” process. Additionally, each of the control device 120 and the drive controller 130 may be referred to as a “target system” in the following description.

Functional Configuration of MFP 10

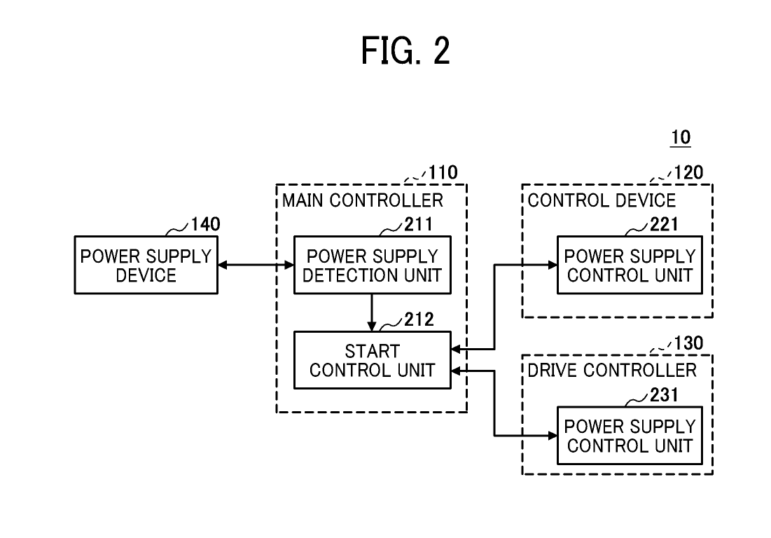

FIG. 2 is a block diagram illustrating a functional configuration of the MFP 10 according to the present embodiment of the disclosure. As illustrated in FIG. 2, the control device 120 includes a power supply control unit 221. Additionally, the drive controller 130 includes a power supply control unit 231. The main controller 110 includes a power supply detection unit 211 and a start control unit 212.

The power supply detection unit 211 detects that the power supplied to the MFP 10 is secured. The power supply detection unit 211 detects that the power supplied to the MFP 10 is secured, when the AC plug 143 of the MFP 10 is plugged into an outlet and a predetermined amount of AC voltage, for example 100V, set by, for example, a designer, is detected in the main power controller 142 of the power supply device 140.

The start control unit 212 controls a boot state of the control device 120 and the drive controller 130. The start control unit 212 causes the control device 120, which does not operates by the mechanical control, to perform the cold boot and then transition to a standby state, (namely instructs the control device 120 to perform the pre-boot, when the power supply detection unit 211 detects that the power supply is secured. On the other hand, the start control unit 212 causes the drive controller 130, which operates by the mechanical control, not to perform the cold boot (namely does not instruct the drive controller 130 to perform the pre-boot.)

Additionally, when the main power switch 141 of the power supply device 140 is switched ON, the start control unit 212 cancels the standby state of the control device 120 and causes the control device 120 to transition to the boot state, namely instructs the control device 120 to boot up. On the other hand, the start control unit 212 causes the drive controller 130 to perform the cold boot to enter the boot state.

The power supply control unit 221 of the control device 120 controls a state of a power supply of the control device 120. For example, when being instructed to perform the pre-boot from the start control unit 212, the power supply control unit 221 performs the pre-boot in the control device 120. Additionally, when being instructed from the start control unit 212 to boot up the control device 120 that is in the standby state, the power supply control unit 221 cancels the standby state of the control device 120 and boots up the control device 120.

The power supply control unit 231 of the drive controller 130 controls an activation state of a power supply of the drive controller 130. For example, when being instructed to boot up from the start control unit 212, the power supply control unit 231 performs the cold boot in the drive controller 130.

Each of the functional units, described above, of the main controller 110, the control device 120, and the drive controller 130, is implemented by, for example, the CPUs (111, 121, and 131) executing a program stored in the memory (the main memory (112, 122, 132) or the auxiliary memory (113, 123, 133,)) of the main controller 110, the control device 120, or the drive controller 130. The program may be provided in the MFP 10 in advance, or provided from the external of the MFP 10. When the program is provided from the external of the MFP 10, a recording medium, such as universal serial bus (USB) memory, a memory card, and compact disc read only memory (CD-ROM), storing the program may be provided, or the program may be downloaded from a server on a network, such as the Internet.

Start Control Process Performed by MFP 10

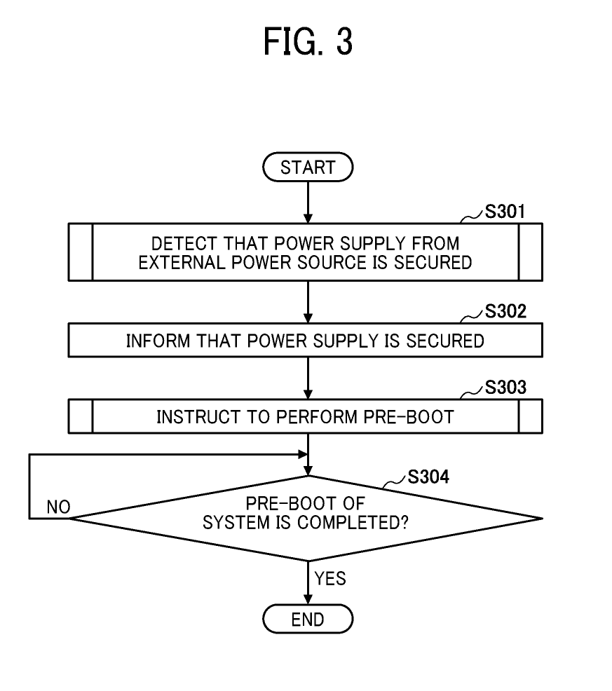

FIG. 3 is a flowchart illustrating a start control process performed by the MFP 10 (main controller 110) according to the present embodiment of the disclosure.

The power supply detection unit 211 detects whether the power supplied from the power source to the MFP 10 is secured (S301). When detecting that the power supply is secured, the power supply detection unit 211 informs the start control unit 212 that the power supply is secured (S302). The start control unit 212 instructs the target system to perform the pre-boot (S303).

Subsequently, the start control unit 212 determines whether the target system completes performing the pre-boot (S304). When S304 determines that the pre-boot is not completed (S304: NO), the start control unit 212 repeats S304. On the other hand when S304 determines that the pre-boot is completed (S304: YES), the main controller 110 completes a series of steps for the start control process illustrated in FIG. 3.

Power Supply Detection Process Performed by MFP 10

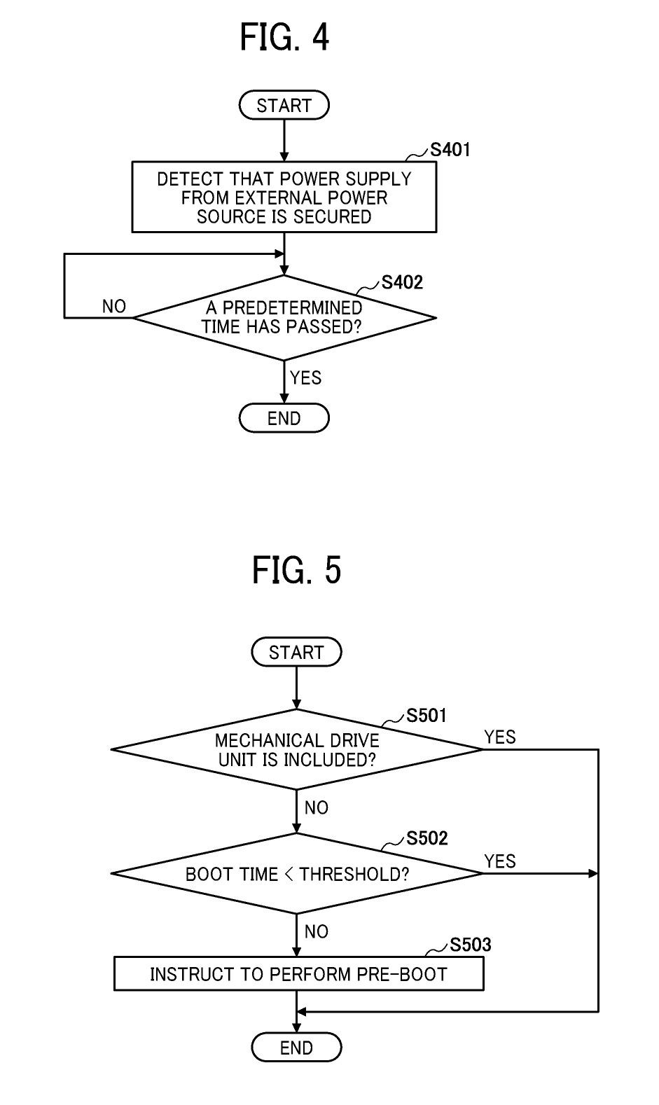

FIG. 4 is a flowchart illustrating a power supply detection process performed by the MFP 10 (main controller 110) according to the present embodiment of the disclosure. The power supply detection process described below is a detailed description of S301 of FIG. 3, which is detecting that the power supply from the external power source is secured.

The power supply detection unit 211 detects that the power supply from the external power source is secured (S401). The power supply detection unit 211, then, determines a predetermined time has passed since when the power supply from the external power source being secured is detected in S401 (S402). The predetermined time is set, for example, by a designer. When determining that the predetermined time has not passed yet, namely the elapsed time from the detection of the power supply does not exceed the predetermined time in S402 (S402: NO), the power supply detection unit 211 repeats S402. On the other hand, when determining that the predetermined time has passed in S402 (S402: YES), the power supply detection unit 211 completes a series of steps for the power supply detection process illustrated in FIG. 4.

With this process, even when the power supply detection unit 211 detects that the power supply from the external power source is secured, the pre-boot is not instructed until the predetermined time elapses, namely the elapsed time from the detection of the power supply becomes equal to or exceeds the predetermined time. This prevents unnecessary pre-boot that occurs each time when the AC plug 143 is plugged into the outlet in a short period of time, or in a case where the AC plug 143 is plugged in and out in a short period of time.

Instruction Process for Pre-Boot Performed by MFP 10

FIG. 5 is a flowchart illustrating an instruction process for the pre-boot, performed by the MFP 10 (main controller 110) according to the present embodiment of the disclosure. The instruction process for the pre-boot described below is a detailed description of S303 of FIG. 3, which is instructing to perform the pre-boot. The pre-boot is instructed to the target system (control device 120, drive controller 130).

The start control unit 212 determines whether each target system has a mechanical drive unit based on, for example, a table (see FIG. 13) (S 501). In the description of the present embodiment, when the target system is the control device 120, the target system is determined “not to have the mechanical drive unit”, and when the target system is the drive controller 130, the target system is determined to “have the mechanical drive unit”.

When the target system is determined to have the mechanical drive unit in S501, (S501: YES), the start control unit 212 completes a series of steps for the instruction process for the pre-boot illustrated in FIG. 5. On the other hand, when the target system is determined not to have the mechanical drive unit in S501, (S501: NO), the start control unit 212 determines whether a boot time of the target system measured in advance is below a threshold based on, for example, a table (see FIG. 13) (S502).

When S502 determines that the boot time, which is measured in advance, is below the threshold (S502: YES), the start control unit 212 completes a series of steps for the instruction process for the pre-boot illustrated in FIG. 5. On the other hand, when S502 determines that the boot time, which is measured in advance, is equal to or above the threshold (S502: NO), the start control unit 212 instructs the target system to perform the pre-boot (S503). The start control unit 212 then, ends the series of steps for the instruction process for the pre-boot illustrated in FIG. 5.

With the instruction process for the pre-boot, the target system that does not have the mechanical drive unit and that has the boot time equal to or larger than the threshold is instructed to perform the pre-boot. As the “threshold” used for the determination performed in S502, the start control unit 212 may use, for example, a boot time of the drive controller 130, “T2” (see FIG. 13), which is set in the table in advance. Accordingly, the boot time of the drive controller 130 is used as a reference value and the target system having a boot time that is longer than the boot time of the drive controller 130 is instructed to perform the pre-boot.

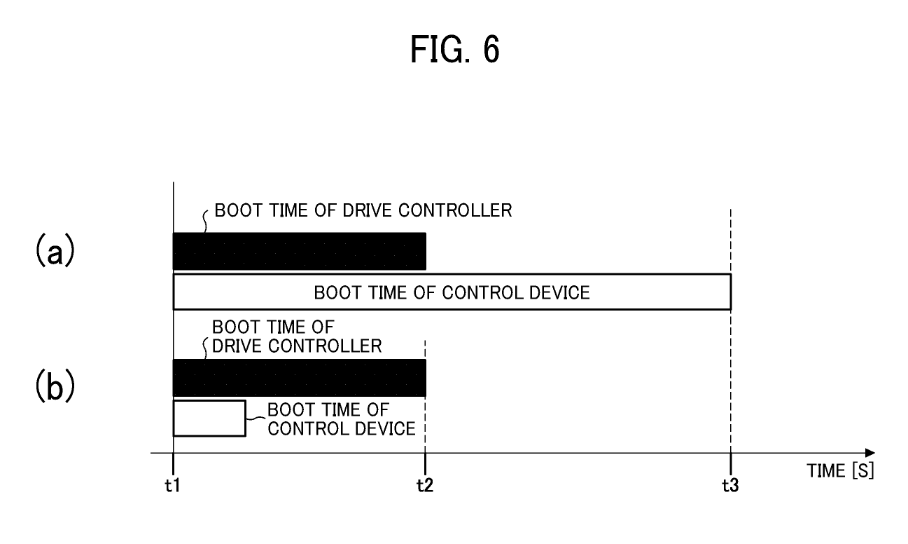

FIG. 6 is a graph illustrating a boot time of an MFP according to a comparative example (a) and the boot time of the MFP 10 according to the present embodiment (b). With (a) of FIG. 6, the boot time of the MFP, according to comparative embodiment, in starting up the first time with a corresponding switch after a corresponding AC plug is plugged into the outlet is illustrated. With (b) of FIG. 6, the boot time of the MFP 10 that starts up the first time with the main power switch 141 after the AC plug 143 is plugged into the outlet is illustrated. (a) of FIG. 6 illustrates the boot time of the MFP according to the comparative example. (b) of FIG. 6 illustrates the boot time of the MFP 10 according to the present embodiment.

Referring (a) in FIG. 6, the MFP according to the comparative example causes a corresponding drive controller and a corresponding control device to individually perform a cold boot process at a time of the first start up (t1 of (a) in FIG. 6) after the corresponding AC plug is plugged into the outlet, so that the entire system takes relatively long time (t3 of (a) in FIG. 6) in the graph to boot up, namely the boot time is long, because a control device system having a high extensibility takes relatively long time.

On the other hand, as illustrated with (b) in FIG. 6, the MFP 10 according to the present embodiment causes the control device 120 to perform the pre-boot in advance at the first start up (t1 of (b) in FIG. 6) after the AC plug 143 is plugged into the outlet, so that the entire system takes relatively short time to boot up in the graph (t2 of (b) in FIG. 6), namely the boot time is short, because the control device 120 simply transitions from the standby state.

[First Modification]

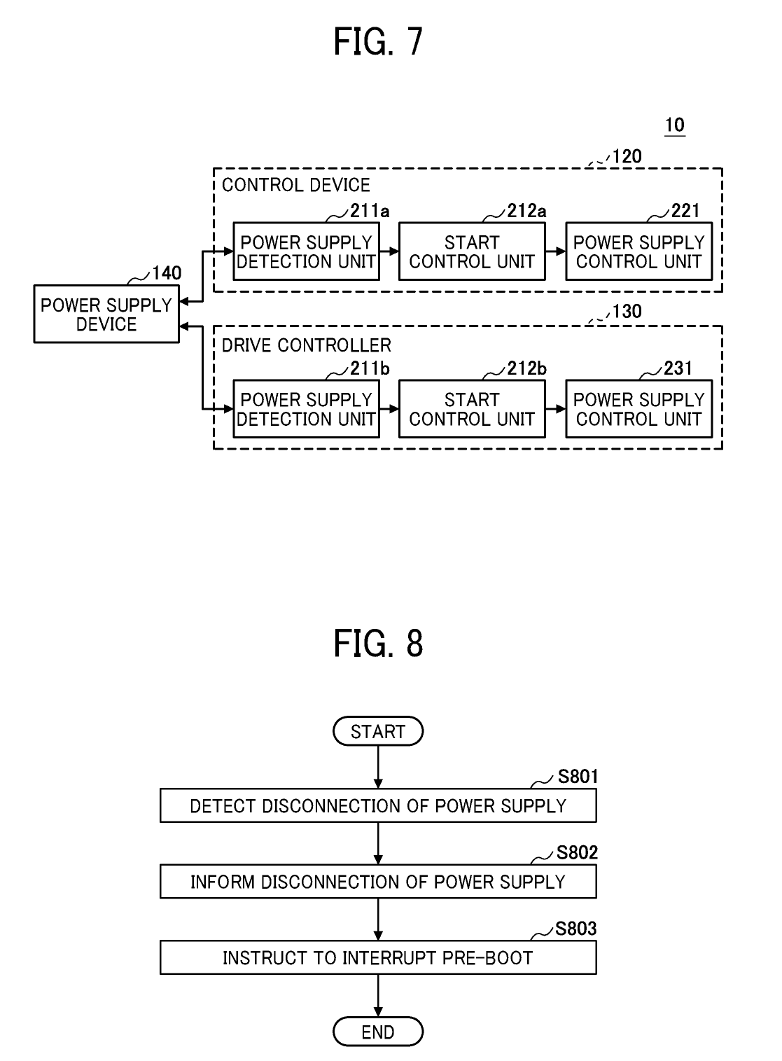

The MFP 10 according to a first modification of the one of the embodiments is described with reference to FIG. 7. FIG. 7 is a diagram illustrating a functional configuration of the MFP 10 according to the first modification (one of the embodiments) of the disclosure. In the functional configuration of the embodiment illustrated in FIG. 2, the power supply detection unit 211 and the start control unit 212 are provided in the main controller 110. Referring to FIG. 7, in the first modification, a power supply detection unit 211a and a start control unit 212a, and a power supply detection unit 211b and a start control unit 212b that are respectively similar to the power supply detection unit 211 and the start control unit 212 are provided in the control device 120 and the drive controller 130, respectively.

In the first modification, the control device 120 is set in advance with a flag to indicate to perform pre-boot, for example. With this setting, the start control unit 212a causes the control device 120 to perform the pre-boot, based on the flag when the power supply detection unit 211a detects that the power supply from the external power source is secured in the control device 120.

On the other hand, the drive controller 130 is set with a flag indicating not to perform the pre-boot. With this setting, the start control unit 212b causes the drive controller 130 not to perform the pre-boot, based on the flag when the power supply detection unit 211b detects that the power supply from the external power source is secured in the drive controller 130.

[Second Modification]

The MFP 10 according to a second modification of the one of the embodiments is described with reference to FIG. 8. FIG. 8 is a flowchart illustrating a pre-boot interruption process performed by the MFP 10 (main controller 110) according to one of the embodiments (second modification) of the disclosure. The main controller 110 of the MFP 10 according to the second modification further includes a function of interrupting the pre-boot.

The power supply detection unit 211 detects disconnection of the power supply (S801). For example, the power supply detection unit 211 detects the discontinuation of the power supply when the predetermined amount of AC voltage, for example, 100V, is not detected with the main power controller 142 of the power supply device 140.

On detecting the disconnection of the power supply in S801, the power supply detection unit 211 notifies the start control unit 212 of the disconnection of the power supply (S802). Subsequently, the start control unit 212 instructs the target system to interrupt the pre-boot (S803). The main controller 110, accordingly, completes the pre-boot interruption process illustrated in FIG. 8.

To perform the process illustrated in FIG. 8, the MFP 10 may include the storage battery 144, such as capacitor or secondary battery, which is chargeable with power required, at least, to interrupt the pre-boot in the power supply device 140 as illustrated in FIG. 1, for example. The MFP 10 may perform the pre-boot after the AC plug 143 is plugged in and the storage battery 144 is fully charged. This allows each target system of the MFP 10 to perform the pre-boot interruption process with the power fully charged in the storage battery 144 after the power supply is stopped.

There is a case where, for example, the user pulls out the AC plug 143 during the pre-boot without noticing that the pre-boot is being performed. In this case, some of the electronic component may be break down because the power supply is stopped during the pre-boot and an amount of voltage that damages the voltage sequence of the electronic component may be applied. Performing the pre-boot interruption process as illustrated in FIG. 8 prevents such a trouble.

[Third Modification]

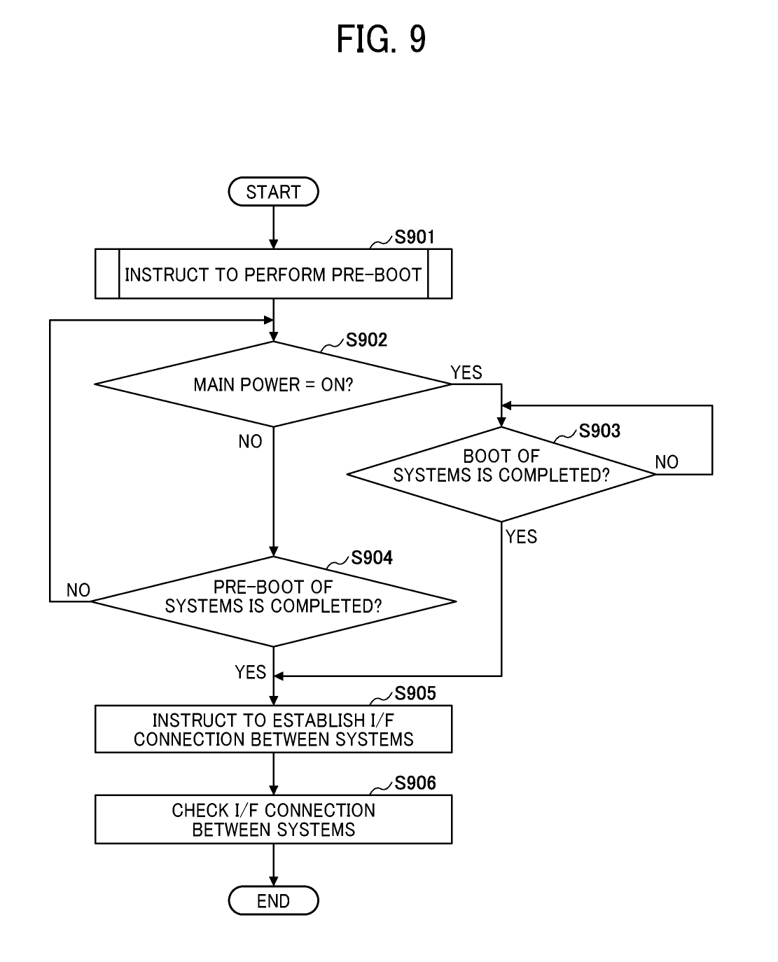

The MFP 10 according to a third modification of the one of the embodiments is described with reference to FIG. 9. FIG. 9 is a flowchart illustrating an interface (I/F) connection establishment process performed by the MFP 10 (main controller 110) according to one of the embodiment (third embodiment). The main controller 110 of the MFP 10 further has a function of establishing an I/F connection.

The start control unit 212 instructs the target system to perform the pre-boot (S901). Subsequently, the start control unit 212 determines whether the main power supply (main power switch 141) of the MFP 10 is ON (S902). If the main power supply of the MFP 10 is ON in S902, (S902: YES), the process proceeds to S903. On the other hand, if the main power supply of the MFP 10 is not ON (S902: NO), the process proceeds to S904.

The start control unit 212 determines whether each target system completes a boot n S903. If S903 determines that the boot is not completed (S903: NO), the start control unit 212 repeats S903. On the other hand, If S903 determines that the boot is completed (S903: YES), the process proceeds to S905.

In S904, the start control unit 212 determines whether each target system completes the pre-boot. If S904 determines that the pre-boot is not completed (S904: NO), the process returns to S902. On the other hand, if S904 determines that the pre-boot is completed (S904: YES), the process proceeds to S905.

In S905, the main controller 110 instructs to the target systems to establish an I/F connection to connect to each other. Subsequently, the start control unit 212 confirms the I/F connection between the target systems (S906), and the main controller 110 completes the process illustrated in FIG. 9.

There is a case where, for example, electricity current may be flown from one into the other of the target systems, or one or both of the target systems may get broken, when the sequence transition of the pre-boot is being performed when the I/F connection between the target systems is established. With the process illustrated in FIG. 9, the I/F connection between the target systems is not established and the target systems are electrically disconnected to each other until the pre-boot or the boot of each target system is completed. After the pre-boot or the boot of each target system is completed, the start control unit 212 instructs to each target system to establish the I/F connection between the target systems and the I/F connection between the target systems is established. This prevents the case described above. Additionally, the process illustrated in FIG. 9 further prevents another case where consistency of the state in the sequence occurs because of a detection error of the state of the sequence caused by a connection to an I/F of the main power supply in response to the switch of the main power supply is turned ON during the sequence transition of the pre-boot.

[Fourth Modification]

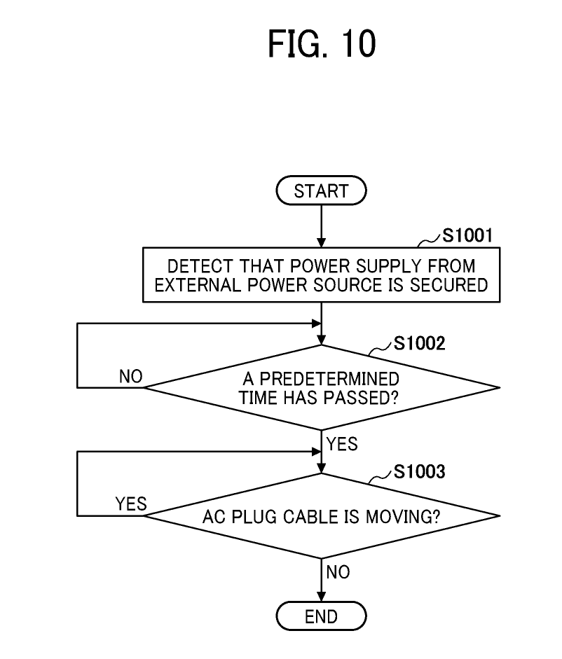

The MFP 10 according to a fourth modification of the one of the embodiments is described with reference to FIG. 10. FIG. 10 is a flowchart illustrating a power supply detection process performed by the MFP 10 (main controller 110) according to one of the embodiments (fourth embodiment) of the disclosure. The power supply detection process illustrated in FIG. 10 is a modification of the power supply detection process illustrated in FIG. 4.

The power supply detection unit 211 detects that the power supply from the external power source is secured (S1001). The power supply detection unit 211, then, determines a predetermined time has passed since when the power supply from the external power source being secured in S1001 (S1002). The predetermined time is set, for example, by a designer. When determining that the predetermined time has not passed yet in S1002 (S1002: NO), the power supply detection unit 211 repeats S1002. On the other hand, when determining that the predetermined time has passed in S1002 (S1002: YES), the process proceeds to S1003.

The power supply detection unit 211 determines whether the cable section of the AC plug 143 is moving or not in S1003. When determining that the cable section of the AC plug 143 is moving in S1003 (S1003: YES), the power supply detection unit 211 repeats S1003. On the other hand, when determining that the cable section of the AC plug 143 is not moving in S1003 (S1003: NO), the process illustrated in FIG. 10 is completed.

To perform the process illustrated in FIG. 10, the MFP 10 may include the acceleration sensor 145 (one example of a moving sensor) in the cable section of the AC plug 143 as illustrated in FIG. 1. This allows the power supply detection unit 211 to determine the cable section of the AC plug 143 is not moving when an output value of the acceleration sensor 145 does not vary for a certain period, and to determine the cable section of the AC plug 143 is moving when the output value of the acceleration sensor 145 varies.

There is a case where, for example, a power tap is used to set and the power tap is moved, and when the pre-boot is started the power tap is moving, unnecessary power consumption may occur because of, for example, the plug is plugged out intentionally due to the movement of the power tap. To prevent such a case, the process as illustrated FIG. 10 in which the pre-boot is not performed when the cable section of the AC plug 143 is moving, is performed The acceleration sensor 145 may be provided in a plug side of the cable section of the AC plug 143, or may be provided in both of the plug side and a body side of the cable section of the AC plug 143.

[Fifth Modification]

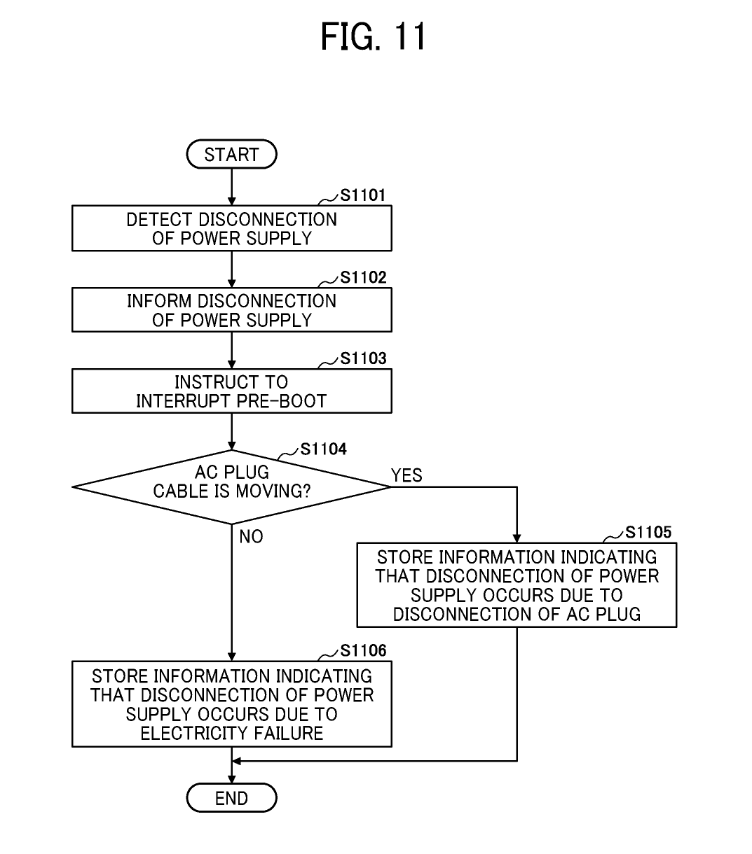

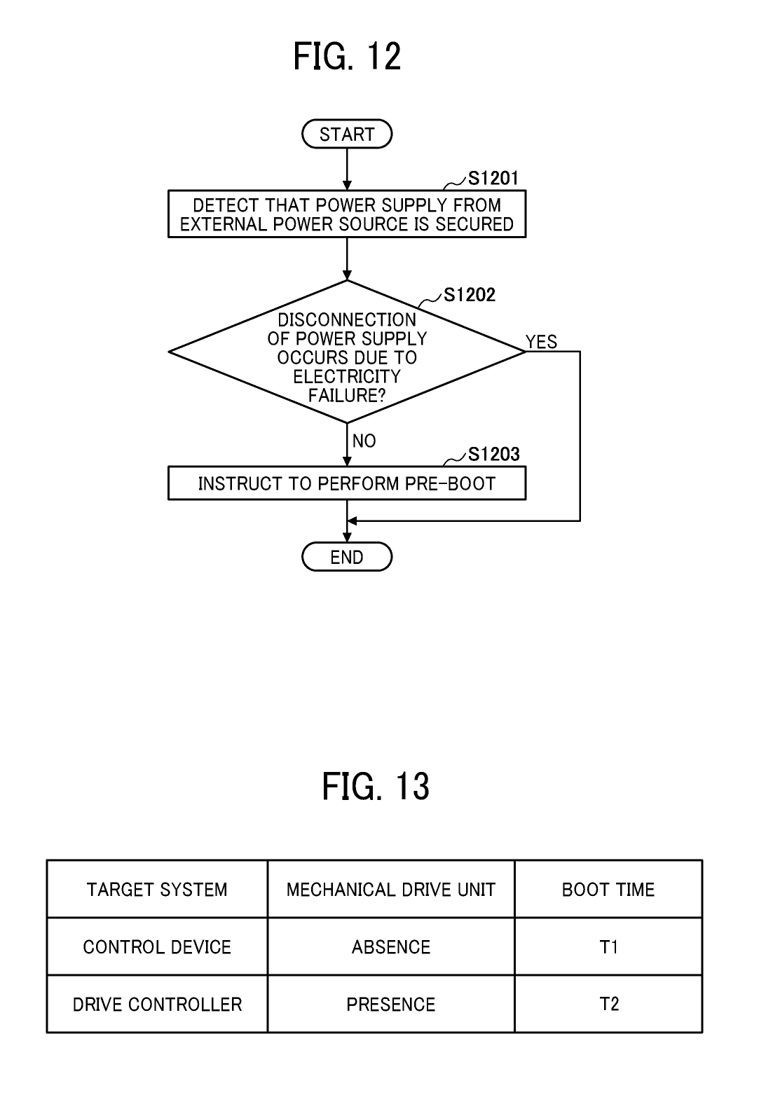

The MFP 10 according to a fifth modification of the one of the embodiments is described with reference to FIGS. 11 and 12.

FIG. 11 is a flowchart illustrating a pre-boot interruption process performed by the MFP 10 (main controller 110) according to one of the embodiments (fifth modification) of the disclosure. The main controller 110 of the MFP 10 according to the fifth modification further includes a function of interrupting the pre-boot.

The power supply detection unit 211 detects disconnection of the power supply (S1101). On detecting the disconnection of the power supply in S1101, the power supply detection unit 211 notifies the start control unit 212 of the disconnection of the power supply (1102). Subsequently, the start control unit 212 instructs the target system to interrupt the pre-boot (S1103).

The power supply detection unit 211 determines whether the cable section of the AC plug 143 is moving or not (S1104). When determining that the cable section of the AC plug 143 is moving in S1104 (S1104: YES), the power supply detection unit 211 stores information indicating that the disconnection of the power supply occurs because the AC plug 143 is plugged out from the outlet, in the nonvolatile memory included in the main controller 110 (S1105). The main controller 110, then, completes the pre-boot interruption process illustrated in FIG. 11. When determining that the cable section of the AC plug 143 is not moving in S1104 (S1104: NO), the power supply detection unit 211 stores information indicating that the disconnection of the power supply occurs because of an electricity failure, in the nonvolatile memory included in the main controller 110 (S1106). The main controller 110, then, completes the pre-boot interruption process illustrated in FIG. 11.

FIG. 12 is a flowchart illustrating a pre-boot check process performed by the MFP 10 (main controller 110) according to the one of the embodiments (fifth modification) of the disclosure. The pre-boot check process illustrated in FIG. 12 is a process performed by the main controller 110 after the information indicating a cause of the disconnection of the power supply is stored, in the process illustrated in FIG. 11, and then the power supply is recovered and secured.

The power supply detection unit 211 detects that the power supply from the external power source is secured (S1201). Subsequently, the power supply detection unit 211 determines the cause of the disconnection of the power supply by referring the nonvolatile memory (S1202).

When S1202 determines that the cause of the disconnection of the power supply is the electricity failure (S1202: YES), the process illustrated in FIG. 12 is completed.

On the other hand, when S1202 determines that the cause of the disconnection of the power supply is not the electricity failure (S1202: NO), the start control unit 212 instructs the target system to perform the pre-boot (S1203). The main controller 110, then, completes the process illustrated in FIG. 12.

There is a case where, for example, reserve power is unnecessarily consumed when each target system performs the pre-boot using the reserve power after recovering from the electricity failure. The processes illustrated FIG. 11 and FIG. 12 prevents such a case by not performing the pre-boot for each target system by setting each target system not to perform the pre-boot after the disconnection of the power supply due to the electricity failure.

### (Example of Table)

FIG. 13 is an example of a table that is stored in the MFP 10 according to one of the embodiment. The table as illustrated in FIG. 13 is stored in the main memory 112 or the auxiliary memory 113 of the main controller 110, for example. Referring to FIG. 13, the table includes information of a presence or an absence of the mechanical drive unit and a boot time for each target system. For example, for the control device 120, the mechanical drive unit and the boot time are set as “absence” and “T1”, respectively, in FIG. 13. For the drive controller 130, the mechanical drive unit and the boot time are set as “presence” and “T2”, respectively. The presence or the absence of the mechanical drive unit is set in advance by a system administrator, for example. Additionally, the boot time may be set in advance by the system administrator or may be automatically set and updated according to a previous actual boot time. For example, the table is referred by the start control unit 212 to determine whether each target system has the mechanical drive unit or not. Additionally, the table is, for example, referred by the start control unit 212 to specify the boot time of each target system.

The above-described embodiments are illustrative and do not limit the present disclosure. Thus, numerous additional modifications and variations are possible in light of the above teachings. It is therefore to be understood that within the scope of the appended claims, the embodiments may be practiced otherwise than as specifically described herein. For example, elements and/or features of different illustrative embodiments may be combined with each other and/or substituted for each other within the scope of the present disclosure.

Additionally, the MFP is used to describe the above-described embodiments, however, is not limiting of the embodiments and alternatively other image forming apparatus than the MFP (e.g, printer, scanner, or projector) may be used. Furthermore, the embodiments of the disclosure is not limited to the image forming apparatus, but adaptable to any apparatus having the mechanical drive unit.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. An electronic apparatus, comprising:
a first controller configured to control a device other than a mechanical device that operates mechanically;
a second controller configured to control the mechanical device that operates mechanically; and
a third controller configured to
detect that power supply to the electronic apparatus is secured, and
cause, in response to detection of the power supply being secured, the first controller to perform a cold boot and transition to a standby state and cause the second controller not to perform the cold boot.

2. The electronic apparatus of claim 1, wherein the third controller causes the first controller to perform the cold boot and transition to the standby state in response to detection of the power supply being secured when a boot time of the first controller measured in advance exceeds a threshold.

3. The electronic apparatus of claim 1, wherein the third controller causes the first controller to perform the cold boot and transition to the standby state when an elapsed time from the detection of the power supply exceeds a predetermined time.

4. The electronic apparatus of claim 1, wherein mechanical device includes at least one of a plotter and a scanner.

5. The electronic apparatus of claim 1, further comprising a storage battery capable of charging power,
wherein, in response to disconnection of the power supply to the electronic apparatus, the third controller instructs the first controller to interrupt the cold boot being performed using the power charged in the storage battery.

6. The electronic apparatus of claim 1, wherein the third controller instructs components of the electronic apparatus to establish an interface connection in response to switching on of a main power after completion of the cold boot performed with the first controller.

7. The electronic apparatus of claim 1, wherein, after switching on of a main power, the third controller instructs components of the electronic apparatus to establish an interface connection in response to completion of boot of each of the components of the electronic apparatus.

8. The electronic apparatus of claim 1, further comprising:
an alternating plug configured to secure the power supply; and
an acceleration sensor configured to detect whether a cable section of the alternating plug is moving, and
wherein the third controller detects that the power supply is being secured, when the acceleration sensor detects that the cable section is not moving

9. The electronic apparatus of claim 8, further comprising
a non-volatile memory,
wherein, when the acceleration sensor detects that the cable section is not moving, the third controller stores in the memory information indicating the power supply is stopped due to an electricity failure in response to detection of disconnection of the power supply, and
the third controller causes the first controller not to perform a cold boot at a next start up based on determination that the non-volatile memory stores the information indicating that the power supply is stopped due to the electricity failure.

10. A method of starting an electronic apparatus including a first controller and a second controller, the first controller being configured to control a device other than a mechanical device that operates mechanically and the second controller being configured to control the mechanical device that operates mechanically, the method comprising:
detecting that power supply to the electronic apparatus is secured; and
causing, in response to detection of the power supply being secured, the first controller to perform a cold boot and transition to a standby state and causing the second controller not to perform the cold boot.

11. A non-transitory recording medium storing a plurality of instructions which, when executed by one or more processors, cause the processors to perform a method of starting an electronic apparatus including a first controller and a second controller, the first controller being configured to control a device other than a mechanical device that operates mechanically and the second controller being configured to control the mechanical device that operates mechanically, the method comprising:
detecting that power supply to the electronic apparatus is secured; and
causing, in response to detection of the power supply being secured, the first controller to perform a cold boot and transition to a standby state and causing the second controller not to perform the cold boot.
